(19) United States
(12) Patent Application Publication
(10) Pub. No.: US 2022/0198264 A1
(43) Pub. Date: Jun. 23, 2022

(54) TIME SERIES ANOMALY RANKING

(71) Applicant: Microsoft Technology Licensing, LLC, Redmond, WA (US)

(72) Inventors: Songtao Guo, Cupertino, CA (US); Robert Perrin REEVES, Castro Valley, CA (US); Bo YANG, Brighton, MA (US); Wan Qi GAO, San Francisco, CA (US); William TANG, Saratoga, CA (US); Patrick Ryan DRISCOLL, Oakland, CA (US); Shan ZHOU, San Jose, CA (US); Taylor Shelby BURFIELD, Greenbrae, CA (US); Adriana Dominique MEZA, Austin, TX (US)

(21) Appl. No.: 17/133,259

(22) Filed: Dec. 23, 2020

(51) Int. Cl. G06N 3/08; G06F 16/23

(52) U.S. Cl. CPC G06N 3/08; G06F 16/2365

(57) ABSTRACT

In an example embodiment, a machine-learned model is trained to rank anomaly points in time series data. The model is capable of being applied in parallel to many different time series simultaneously, allowing for a scalable solution for large scale online networks. The model outputs a ranking score for an input anomaly and allows for ranking of anomalies not just in the same time series but anomalies across multiple time series as well. This ranking can then be used to determine how best to present the ranked anomalies to users in a graphical user interface.

### CROSS-RELATION TO PATENT APPLICATION

The present application is related to the Application entitled “TIME SERIES ANOMALY DETECTION” by Songtao Guo, Patrick Ryan Driscoll, Michael Mario Jennings, Robert Perrin Reeves and Bo Yang, filed concurrently with the present application on the same day, hereby incorporated-by-reference in its entirety.

### TECHNICAL FIELD

The present disclosure generally relates to technical problems encountered in machine learning. More specifically, the present disclosure relates to time series anomaly ranking.

### BACKGROUND

The rise of the Internet has occasioned two disparate yet related phenomena: the increase in the presence of online networks, with their corresponding user profiles visible to large numbers of people, and the increase in the use of these online networks to provide content. Online networks are able to gather and track large amounts of data regarding various entities, including organizations and companies. For example, online networks are able to track users who transition from one company to another company and thus, in aggregate, these online networks are able to determine, for example, how many users have left a particular company in a particular time period. Additional details may be known and/or added to these types of metrics, such as which companies the users left the company for, and how many users have joined the particular company during the same time period. Additionally, there are many other metrics that online networks could determine about these companies that may be of interest to users.

An issue arises, however, in determining what to do with this information. There are so many potential metrics and values for the metrics that it can be difficult to determine which metric/value may be more important to convey to users.

An additional technical issue arises in the context of large online networks. Specifically, when dealing with large online networks, the amount of data to be analyzed is enormous. As such, any potential solution would need to be scalable to operate in large online networks.

### BRIEF DESCRIPTION OF THE DRAWINGS

Some embodiments of the technology are illustrated, by way of example and not limitation, in the figures of the accompanying drawings.

FIG. 1 is a block diagram illustrating a client-server system, in accordance with an example embodiment.

FIG. 2 is a block diagram showing the functional components of an online network, including a data processing module referred to herein as a search engine, for use in generating and providing search results for a search query, consistent with some embodiments of the present disclosure.

FIG. 3 is a block diagram illustrating application server module of FIG. 2 in more detail, in accordance with an example embodiment.

FIG. 4 is a diagram illustrating the difficulty in comparing anomalies from multiple time series, in accordance with an example embodiment.

FIG. 5 is a screen capture illustrating an insights screen of a Graphical User Interface (GUI), in accordance with an example embodiment.

FIG. 6 is a screen capture illustrating an anomaly report screen of GUI, in accordance with an example embodiment.

FIG. 7 is a flow diagram illustrating a method of training and using a machine learned model, in accordance with an example embodiment.

FIG. 8 is a block diagram illustrating a software architecture, in accordance with an example embodiment.

FIG. 9 illustrates a diagrammatic representation of a machine in the form of a computer system within which a set of instructions may be executed for causing the machine to perform any one or more of the methodologies discussed herein, according to an example embodiment.

### DETAILED DESCRIPTION

### Overview

The present disclosure describes, among other things, methods, systems, and computer program products that individually provide various functionality. In the following description, for purposes of explanation, numerous specific details are set forth in order to provide a thorough understanding of the various aspects of different embodiments of the present disclosure. It will be evident, however, to one skilled in the art, that the present disclosure may be practiced without all of the specific details.

In an example embodiment, a machine-learned model is trained to rank anomaly points in time series data. The model is capable of being applied in parallel to many different time series simultaneously, allowing for a scalable solution for large scale online networks. The model outputs a ranking score for an input anomaly and allows for ranking of anomalies not just in the same time series but anomalies across multiple time series as well. This ranking can then be used to determine how best to present the ranked anomalies to users in a GUI. In prior art software solutions, anomaly ranking needed to be handled serially, and thus anomaly ranking in time series data on the scale of millions or even billions of data points could not be performed in a reasonable amount of time. In an example embodiment, the anomaly ranking is able to be performed on each time series in parallel, allowing anomaly ranking in time series data on the scale of millions or billions of data points to be performed in a reasonable amount of time.

### DESCRIPTION

The disclosed embodiments provide a method, apparatus, and system for training a machine-learned model using a machine learning algorithm to rank anomalous data points in discrete time series. A discrete time series comprises data points separated by time intervals. These time intervals may be regular (e.g., once a month) or irregular (e.g., each time a user logs in). While this disclosure will provide specific examples where the time intervals are regular, one of ordinary skill in the art will recognize that there may be circumstances where the techniques described in the present disclosure can be applied to discrete time series with irregular time intervals.

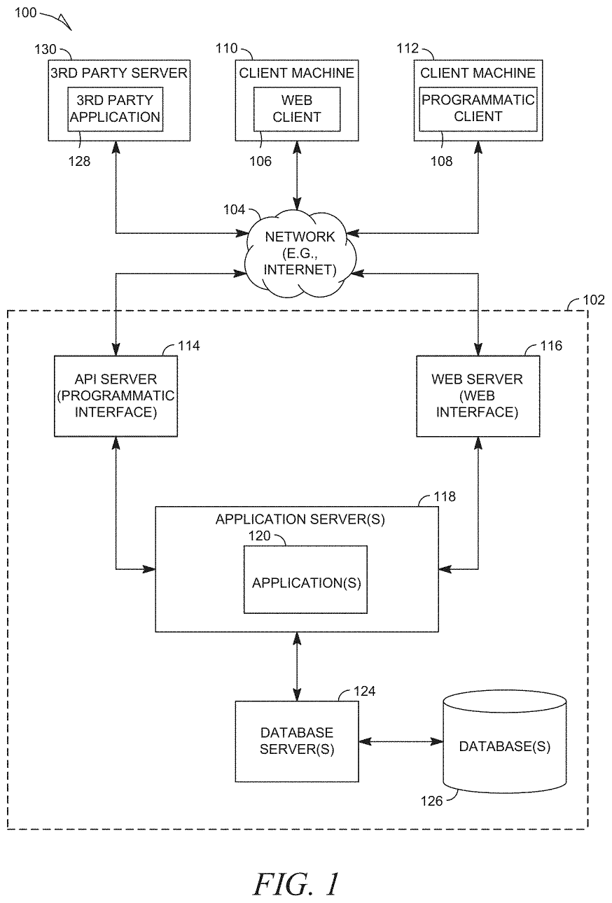

FIG. 1 is a block diagram illustrating a client-server system 100, in accordance with an example embodiment. A networked system 102 provides server-side functionality via a network 104 (e.g., the Internet or a wide area network (WAN)) to one or more clients. FIG. 1 illustrates, for example, a web client 106 (e.g., a browser) and a programmatic client 108 executing on respective client machines 110 and 112.

An application program interface (API) server 114 and a web server 116 are coupled to, and provide programmatic and web interfaces respectively to, one or more application servers 118. The application server(s) 118 host one or more applications 120. The application server(s) 118 are, in turn, shown to be coupled to one or more database servers 124 that facilitate access to one or more databases 126. While the application(s) 120 are shown in FIG. 1 to form part of the networked system 102, it will be appreciated that, in alternative embodiments, the application(s) 120 may form part of a service that is separate and distinct from the networked system 102.

Further, while the client-server system 100 shown in FIG. 1 employs a client-server architecture, the present disclosure is, of course, not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the application(s) 120 via the programmatic interface provided by the API server 114.

FIG. 1 also illustrates a third-party application 128, executing on a third-party server 130, as having programmatic access to the networked system 102 via the programmatic interface provided by the API server 114. For example, the third-party application 128 may, utilizing information retrieved from the networked system 102, support one or more features or functions on a website hosted by a third party. The third-party website may, for example, provide one or more functions that are supported by the relevant applications 120 of the networked system 102.

In some embodiments, any website referred to herein may comprise online content that may be rendered on a variety of devices including, but not limited to, a desktop personal computer (PC), a laptop, and a mobile device (e.g., a tablet computer, smartphone, etc.). In this respect, any of these devices may be employed by a user to use the features of the present disclosure. In some embodiments, a user can use a mobile app on a mobile device (any of the machines 110, 112 and the third-party server 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

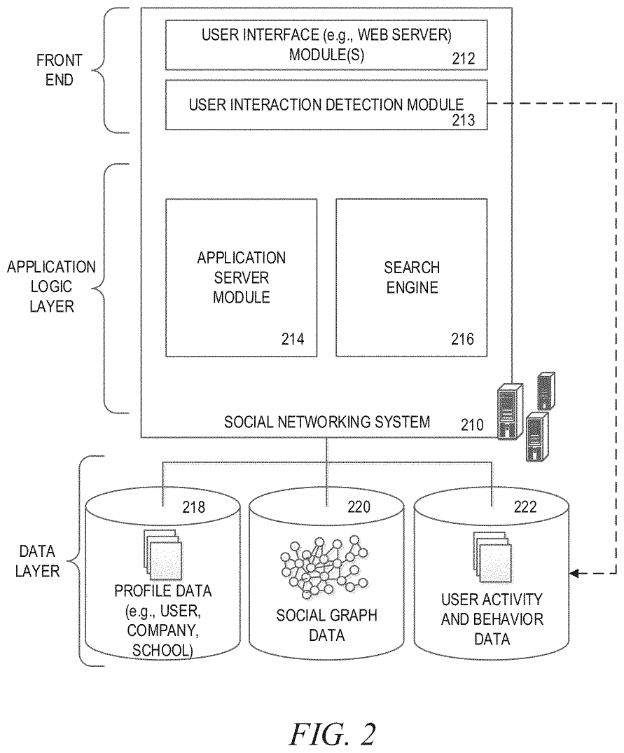

In some embodiments, the networked system 102 may comprise functional components of an online network. FIG. 2 is a block diagram showing the functional components of an online network, including a data processing module referred to herein as a search engine 216, for use in generating and providing search results for a search query, consistent with some embodiments of the present disclosure. In some embodiments, the search engine 216 may reside on the application server(s) 118 in FIG. 1. However, it is contemplated that other configurations are also within the scope of the present disclosure.

As shown in FIG. 2, a front end may comprise a user interface module (e.g., a web server 116) 212, which receives requests from various client computing devices and communicates appropriate responses to the requesting client devices. For example, the user interface module(s) 212 may receive requests in the form of Hypertext Transfer Protocol (HTTP) requests or other web-based API requests. In addition, a user interaction detection module 213 may be provided to detect various interactions that users have with different applications 120, services, and content presented. As shown in FIG. 2, upon detecting a particular interaction, the user interaction detection module 213 logs the interaction, including the type of interaction and any metadata relating to the interaction, in a user activity and behavior database 222.

An application logic layer may include one or more various application server modules 214, which, in conjunction with the user interface module(s) 212, generate various user interfaces (e.g., web pages) with data retrieved from various data sources in a data layer. In some embodiments, individual application server modules 214 are used to implement the functionality associated with various applications 120 and/or services provided by the online network.

As shown in FIG. 2, the data layer may include several databases 126, such as a profile database 218 for storing profile data, including both user profile data and profile data for various organizations (e.g., companies, schools, etc.). Consistent with some embodiments, when a person initially registers to become a user of the online network, the person will be prompted to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 218. Similarly, when a representative of an organization initially registers the organization with the online network, the representative may be prompted to provide certain information about the organization. This information may be stored, for example, in the profile database 218, or another database (not shown). In some embodiments, the profile data may be processed (e.g., in the background or offline) to generate various derived profile data. For example, if a user has provided information about various job titles that the user has held with the same organization or different organizations, and for how long, this information can be used to infer or derive a user profile attribute indicating the user's overall seniority level or seniority level within a particular organization. In some embodiments, importing or otherwise accessing data from one or more externally hosted data sources may enrich profile data for both users and organizations. For instance, with organizations in particular, financial data may be imported from one or more external data sources and made part of an organization's profile. This importation of organization data and enrichment of the data will be described in more detail later in this document.

Once registered, a user may invite other users, or be invited by other users, to connect via the online network. A “connection” may constitute a bilateral agreement by the users, such that both users acknowledge the establishment of the connection. Similarly, in some embodiments, a user may elect to “follow” another user. In contrast to establishing a connection, the concept of “following” another user typically is a unilateral operation and, at least in some embodiments, does not require acknowledgement or approval by the user that is being followed. When one user follows another, the user who is following may receive status updates (e.g., in an activity or content stream) or other messages published by the user being followed, relating to various activities undertaken by the user being followed. Similarly, when a user follows an organization, the user becomes eligible to receive messages or status updates published on behalf of the organization. For instance, messages or status updates published on behalf of an organization that a user is following will appear in the user's personalized data feed, commonly referred to as an activity stream or content stream. In any case, the various associations and relationships that the users establish with other users, or with other entities and objects, are stored and maintained within a social graph in a social graph database 220.

As users interact with the various applications 120, services, and content made available via the online network, the users' interactions and behavior (e.g., content viewed, links or buttons selected, messages responded to, etc.) may be tracked, and information concerning the users' activities and behavior may be logged or stored, for example, as indicated in FIG. 2, by the user activity and behavior database 222. This logged activity information may then be used by the search engine 216 to determine search results for a search query.

In some embodiments, the databases 218, 220, and 222 may be incorporated into the database(s) 126 in FIG. 1. However, other configurations are also within the scope of the present disclosure.

Although not shown, in some embodiments, a social networking system 210 provides an API module via which applications 120 and services can access various data and services provided or maintained by the online network. For example, using an API, an application may be able to request and/or receive one or more recommendations. Such applications 120 may be browser-based applications 120 or may be operating system-specific. In particular, some applications 120 may reside and execute (at least partially) on one or more mobile devices (e.g., phone or tablet computing devices) with a mobile operating system. Furthermore, while in many cases the applications 120 or services that leverage the API may be applications 120 and services that are developed and maintained by the entity operating the online network, nothing other than data privacy concerns prevents the API from being provided to the public or to certain third parties under special arrangements, thereby making the navigation recommendations available to third-party applications 128 and services.

Although features of the present disclosure are referred to herein as being used or presented in the context of a web page, it is contemplated that any user interface view (e.g., a user interface on a mobile device or on desktop software) is within the scope of the present disclosure.

In an example embodiment, when user profiles are indexed, forward search indexes are created and stored. The search engine 216 facilitates the indexing and searching for content within the online network, such as the indexing and searching for data or information contained in the data layer, such as profile data (stored, e.g., in the profile database 218), social graph data (stored, e.g., in the social graph database 220), and user activity and behavior data (stored, e.g., in the user activity and behavior database 222). The search engine 216 may collect, parse, and/or store data in an index or other similar structure to facilitate the identification and retrieval of information in response to received queries for information. This may include, but is not limited to, forward search indexes, inverted indexes, N-gram indexes, and so on.

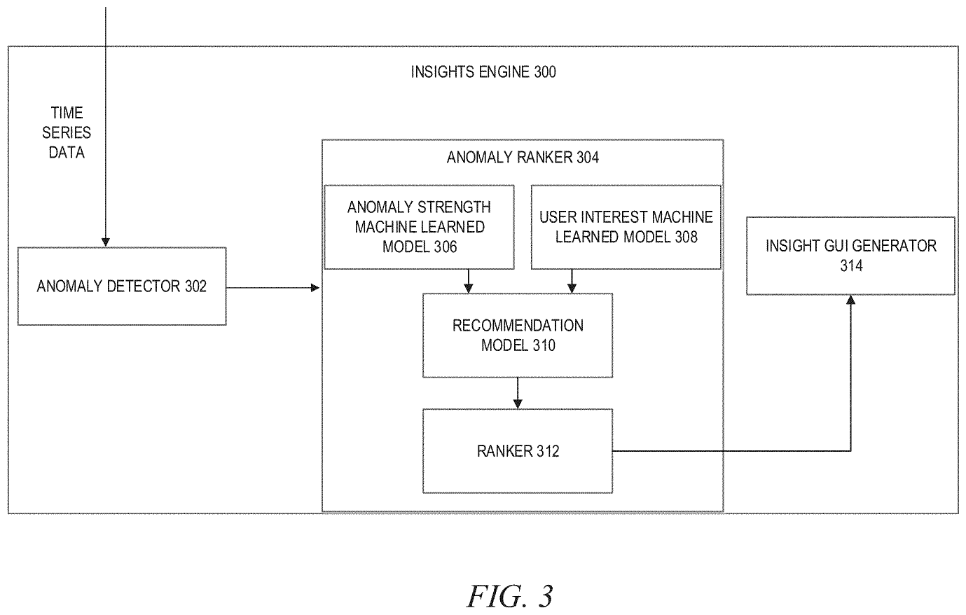

FIG. 3 is a block diagram illustrating application server module 214 of FIG. 2 in more detail, in accordance with an example embodiment. While in many embodiments the application server module 214 will contain many subcomponents used to perform various different actions within the social networking system 210, in FIG. 3 only those components that are relevant to the present disclosure are depicted.

An insights engine 300 may generate one or more insights regarding data obtained from one or more databases. These databases may include, for example, profile database 218, social graph database 220, and/or user activity and behavior database 222, among others. In an example embodiment, the insights engine 300 may include an anomaly detector 302 and an anomaly ranker 304. The anomaly detector 302 acts to identify one or more anomalies in one or more time series generated from data obtained from the databases 218, 220, 222. The anomaly ranker 304 then ranks these identified anomalies. The present disclosure focuses on the anomaly ranker 304 component.

In an example embodiment, the anomaly ranker 304 includes an anomaly strength machine learned model 306 that is trained to generate an anomaly strength score for an input anomaly (such as those detected by the anomaly detector 302) and normalize the anomaly strength score for cross-time series comparisons. In other words, the anomaly strength score is indicative of both the magnitude of the anomaly's variation from the expected value in the time series where the anomaly lies as well, normalized based on the relative importance of this variation with respect to variations of anomalies in other time series. This model respects both the anomaly's deviation from other neighbor points as well as the gap between expectation and observation.

Definition 1. (Univariate time series) A univariate time series X={xₜ}_{t∈T} is an ordered set of real-valued observations, where each observation is recorded at a specific time t∈T⊆Z⁺. Then, xₜ is the point or observation collected at time t and X_{[p,p+n-1]}=xₚ, xₚ₊₁, . . . , xₚ₊ₙ₋₁ is the subsequence of length n≤|T| starting at position p of the time series X, for p, t∈T and p≤|T|−n+1. It is assumed that each observation xₜ is a realized value of a certain random variable Xₜ. In an example embodiment, all the values in a time series are non-negative integers.

Definition 2. (Anomaly) given a univariate time series, a point at time t can be declared an anomaly if the distance to its expected value is higher than a predefined threshold τ:

|xₜ−\hat{x}ₜ|>τ

where xₜ is the observed data point, and \hat{x}ₜ is the corresponding expected value.

There are various ways to compute \hat{x}ₜ and τ, but they are all based on fitting a model. In an example embodiment, prediction model-based methods are used where \hat{x}ₜ is estimated based on previous observations to xₜ (past data).

Prior art techniques for ranking anomalies only do so with respect to anomalies in a single time series. They are not applicable when comparing two anomalies from different time series. In the present disclosure, there is a need to not only detect anomalies from a univariate time series, but also to compare anomalies across different time series so that the ones with the highest anomaly strength can be recommended to users.

A technical problem exists in determining how to measure the strength of anomalies with ranking function ƒ(x) detected from different time series while still satisfying desired properties such as:
From the same univariate time series, the strength of anomalies with the highest strength (xₜ>z⁺) should be monotonically increasing by their magnitudes, and the strength of anomalies with lower strength (xₜ<z⁻) should be monotonically decreasing by their magnitudes. Here [z⁻, z⁺] is a prediction interval used to define an anomaly

xₜ≥xₜ′,xₜ>z⁺& xₜ′>z⁺→ƒ(xₜ)≥ƒ(xₜ′)

xₜ≥xₜ′,xₜ<z⁻& xₜ′<z⁻→ƒ(xₜ)≤ƒ(xₜ′)
From different time series, one expects the score should be consistent with a consistent seasonal effect
It should reflect the difference between the forecasted value and observed value. The larger the gap, the higher the score.
It should be robust enough to analyse anomalies across the time series length

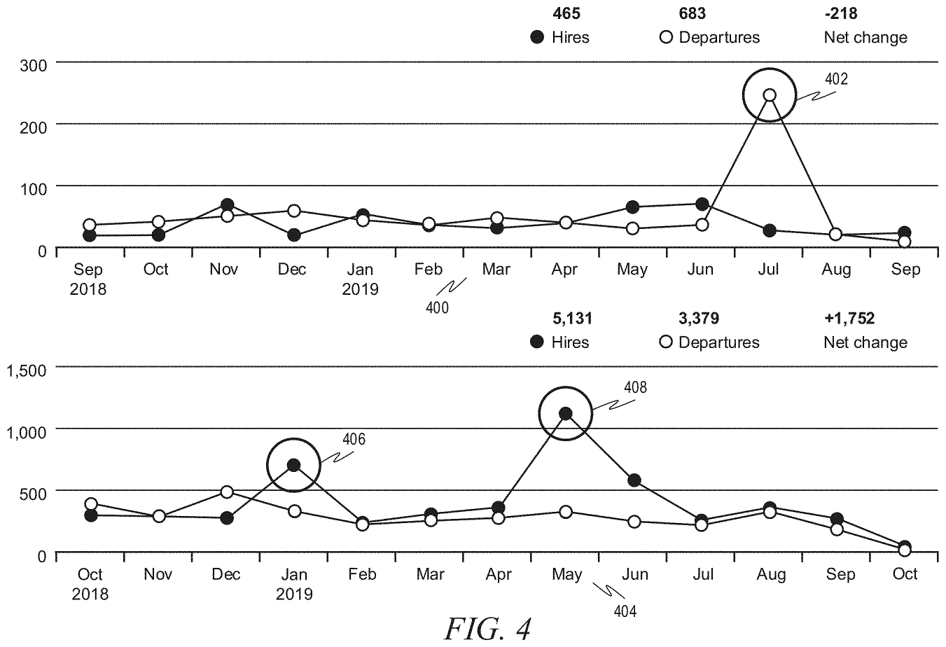

FIG. 4 is a diagram illustrating the difficulty in comparing anomalies from multiple time series, in accordance with an example embodiment. Specifically, graph 400 depicts an anomaly 402 detected in a first time series, whereas graph 404 depicts anomalies 406, 408 detected in a second time series. Notably, while it might be straightforward to determine the relative strength of anomaly 406 in comparison to anomaly 408 since both are in the same time series, it is quite difficult to determine the relative strength of anomaly 406 to anomaly 402 or anomaly 408 to anomaly 402, since they are in different time series.

In an example embodiment, a specialized anomaly strength score is computed for anomalies in an anomaly detection window in time series data. The length of the anomaly detection window may be fixed or may be dynamically determined. The dynamic determination may be performed using its own machine learning algorithm. Indeed, this length may be personalized for different contexts. For example, certain types of time series may have longer anomaly detection window lengths than others, or it may be customized based on the company the data applies to, or to the viewer. In an example embodiment, a mapping between contexts and lengths may be maintained such that the process involves determining a current context, retrieving a corresponding length from the mapping, and using that length for the anomaly detection window. In another example embodiment, another machine learned model can be trained to output a length for an input context/user/company. For example, data about past interactions by user A (or users similar to user A) with a graphical user interface displaying anomalous data points can be used to train a model that predicts the anomaly detection window length that has the highest probability of causing user A to interact with the results of the time series analysis provided in the graphical user interface.

In an example embodiment, the dynamic anomaly detection window length may be determined by first obtaining past interactions in a group of sample data. This group may be determined based on a common characteristic (whether broad or narrow) among the sample data in the group, and the common characteristic can be selected to be any attribute that one would want to “personalize” or customize the length for. In the narrow case, sample data only pertaining to an individual user and users similar to the individual user (as determined by more than a threshold similarity of user profile information, such as employment history, education, location, and skills) can be obtained. In a more broad case, sample data pertaining to all users employed at a particular employer can be obtained. No matter the common characteristic, the sample data may include interactions between users and anomalies presented in a graphical user interface. These interactions may be positive (such as selecting on or hovering over the presented anomaly to view additional information about the presented anomaly), or negative (such as having been presented with the anomaly but not selecting it, or dismissing it if such an option is provided). The positive and negative interactions may be labelled as positive or negative, respectively, and fed to a machine learning algorithm to train a specialized anomaly window length determination machine learned model. The training may include learning weights (coefficients) to be applied to feature data about users. The anomaly window length determination machine learned model may then apply these weights to feature data for a particular user to which the graphical user interface may be currently presented, outputting a specialized anomaly length for the particular user, thus dynamically determining the anomaly window length and potentially affecting how anomalies are ranked for particular users.

The computation of the specialized anomaly strength score utilizes a specialized score, which will be called a modified Z score, to aid in determining anomaly strength across different time series. The algorithm below may be implemented by the anomaly strength machine learned model 306:

Algorithm 1: NormAnomalyStrength

Input:
A univariate time series X: = {xₜ}_{t∈T}
Anomaly detection window length: k
Output:
S_{[T-k-1, T]}: normalized anomaly strength scores for all the data points in the anomaly
detection window
Method:
1. Decompose time series using Multiple Seasonal Decomposition (MSTL) into
Trend, Seasonal and Remainder (noise) components
X = C_{trend} + Cₛₑₐₛₒₙₐₗ_{₁} + . . . + Cₛₑₐₛₒₙₐₗ_{_{M}} + Cₙₒᵢₛₑ
2. Derive a new noise component by augmenting Trend with more robust running
median Cₙₒᵢₛₑ′ = Cₙₒᵢₛₑ + C_{trend} - RUNMED(C_{trend}, k_{window-size})
3. Use Friedman’s SuperSmoother algorithm for non-seasonal series and a periodic
Seasonal and Trend (STL) decomposition with seasonal series to identify anomalies
from Cₙₒᵢₛₑ′ and suppress them from X
X′ = X − (Cₙₒᵢₛₑ′ - anomaly(Cₙₒᵢₛₑ′))
4. Calculate modified Z score to measure anomaly strength:
Z = ModifiedZScore(round(X′)), where round() convert time series to its integer
form
5. Normalize Z with a Sigmoid function

| | | |
|---|---|---|
| For z ∈ Z , ${z}^{′} = \frac{2}{1 + {e}^{- α * \vert z \vert}} - 1 ,$ | where $α = \frac{log ( 3 )}{τ} ,$ | τ is a ranking threshold |

6. Split X’ into training and testing sequences:
X′ = Xₜᵣₐᵢₙ′ ∪ Xₜₑₛₜ′ where Xₜᵣₐᵢₙ′= X_{[1,T-k]}′ = X_{[T-k-1,T]}′
7. Build a time series model (ARIMA or ETS) with Xₜᵣₐᵢₙ′ and estimate values for
Xₜₑₛₜ′: \hat{X}ₜₑₛₜ′
8. Calculate discounted anomaly strength for all the data points in the detection
window ${S}_{[ T - k - 1 , T ]} = \{ {S}_{t} \vert {z}_{t}^{′} * \frac{1}{1 + {φ}^{- \vert {x}_{t}^{′} - {\hat{x}}_{t}^{′} \vert * β}} \} ( t ∈ [ T - k - 1 , T ] )$
where x′ ϵ Xₜₑₛₜ′, \hat{x}′ ϵ \hat{X}ₜₑₛₜ′, φ and β are empirical parameters to control the slope
and shift of the sigrnoid function
Return: S_{[T-k-1, T]}

This algorithm has the following advantages. First, it reduces the influence of anomalies in the training data to the estimation in the anomaly detection window. Steps 1-3 carefully preserve desired seasonal and trend information while removing undesired anomalies from the remainder (noise) component of a given time series. This is accomplished by first decomposing the time series data into trend, seasonal, and noise components. There is only one trend component and only one noise component for each time series, but there may be one or more seasonal components. MSTL may be used for this process.

MSTL is a function that handles potentially multiple seasonability time series. It operates by iteratively estimating each seasonal component using a seasonal-trend decomposition such as STL. The trend component is computed for the last iteration of STL. STL is a filtering procedure for decomposing a seasonal time series. STL comprises two recursive procedures: an inner loop nested inside an outer loop. In each of the passes through the inner loop, the seasonal and trend components re updated once. Each complete run of the inner loop comprises n₍ᵢ₎ such passes. Each pass of the outer loop comprises the inner loop followed by a computation of robustness weights. These weights are used in the next run of the inner loop to reduce the influence of transient, aberrant behavior on the trend and seasonal components. An initial pass of the outer loop is carried out with all robustness weights equal to 1, and then n(o) passes of the outer loop are carried out. In an example embodiment, n(o) and n(i) are preset and static.

Each pass of the inner loop comprises a seasonal smoothing that updates the seasonal component, followed by a trend smoothing that updates the trend component. Specifically, a detrended series is computed. Then each subseries of the detrended series is smoothed by a smoother such as a Loess smoother. Low pass filtering is then applied to the smoothed subseries, and a seasonal component is subtracted from the smoothed and filtered subseries. This is known as detrending the smoothed subseries. A deseasonalized series is then computed. The deseasonalized series is then smoothed (such as by using a Loess smoother).

An outer loop then defines a weight for each time point where the time series does not have missing values. These weights are known as robustness weights and reflect how extreme the remainder is (the time series minus the trend component minus the seasonal component). The robustness weights may be computed using a bisquare weight function. The inner loop is then repeated, but in the smoothings, a neighbourhood weight for a value at a particular time is multiplied by the corresponding robustness weight.

The iterations may continue until a preset number of iterations has occurred.

Referring back to the algorithm, after decomposition, rounding is applied to avoid extreme values in the modified Z score in step 4. Then, normalization is applied on the unbounded modified Z score to make it more comparable across different types of insights in downstream rankers (described later). The score is bounded within the [0, 1] range.

It is expected that the final anomaly strength score is a reflection of the difference between the forecasted value and an observed value. The larger the gap, the higher the score. To achieve this, a discounting function is applied in step 8. For a short time series, such as less than 2 periods, steps 1-3 may be skipped.

Modified Z score may be defined as follows:

For a set X={xᵢ|xᵢ∈ [symbol] , i=1, 2, . . . , n}, let \tilde{X}=median(A)
Median Absolute Deviation (MAD) is defined as:

MAD=median(|xᵢ−\tilde{X}|)

Mean Absolute Deviation (MeanAD) is defined as:

$$MeanAd = \frac{1}{n} {\sum }_{i}^{n} \vert {x}_{i} - m ( X ) \vert$$

where the measure of central tendency, m(X) can be mean, median, mode where

$$Z = \{ \begin{matrix}\frac{{x}_{i} - \tilde{X}}{{k}_{1} \cdot MeanAd} & ( MAD = 0 ) \\ \frac{{x}_{i} - \tilde{X}}{{k}_{2} \cdot MAD} & ( M A D \neq 0 )\end{matrix}$$

and k₁ and k₂ are weights that can be learned via training or a machine learned model using a machine learning algorithm (and potentially retraining at a later time based on user feedback, which could include subsequent interaction data or alternative means of feedback, such as questionnaire or survey responses). The machine learning algorithm may utilize training data in the form of user profiles and user interaction data and can learn which values of k₁ and k₂ maximize user selection on ranked anomalies in an anomaly reporting tool of a graphical user interface. Thus, for example, the algorithm may learn which values of k₁ and k₂ cause a particular user, or users like a particular user, to click most often on displayed ranked anomalies. Values of k₁ and k₂ can be learned via a process similar to that described above with respect to learning anomaly detection window length. It should be noted that this is a different process than will be described later regarding training the separate user interest machine learned model 308, which is used to independently score the detected anomalies based on user interest (without regard for anomaly strength).

MAD may be used to estimate the population standard deviation and use an anomaly cutoff that is appropriate to the assumed underlying distribution. The cutoff indicates at what value above which a data point is considered an anomaly. In an example embodiment, this anomaly cutoff is learned via machine learning algorithm, such as a logistic regression algorithm or a neural network, much in the same way the machine learning algorithm in the anomaly detection section described above is used to learn weights and values used during that process. This would be a separate machine learning process than those used to train the anomaly strength machine learned model 306 or user interest machine learned model 308.

Referring back to FIG. 3, in an example embodiment, the anomaly ranker 304 further includes a user interest machine learned model 308. The user interest machine learned model 308 is trained via a machine learning algorithm to output a score for a given insight (such as a detected anomaly) based on how likely it is that a user (such as the viewer of a GUI in which the insight may be highlighted) would be interested in the insight. Interest can be measured as a function of user selections within a GUI (e.g., clicks on the insight or links representing the insight). The training of the user interest machine learned model 308 may use as input various features of training data, which may include user profiles, company profiles (for the companies for which the time series data apply), and company peer group member profiles, among others. A peer group for a company is a group of other companies that are similar to the company, such as companies in the same industry and around the same size.

In supervised machine learning, input data or training examples come with a label, and the goal of the learning is to be able to predict the label for new, unforeseen examples. In this present case, the label is defined as a binary fact of whether or not a user is interested in an insight.

Positive and negative labels can be collected from a variety of different sources. In an example embodiment, five sources for positive and negative labels may be onboarded in parallel. The first is a positive search. This is a case where a user explicitly searches for or selects on a link indicating an interest in a particular report that contains insights. The second is a recruiter search. These include positive labels inferred based on activity within a recruiter tool. The recruiter tool may comprise a GUI that allows users, such as recruiters, to perform searches for other users based on characteristics of the other users, such as skills. Positive labels may be inferred for active users within the recruiter tool, under the assumption that users who are more active in searching for other users are also more likely to be interested in insights from time series data.

The third is search exclusion. Negative labels may be implied from faceted search query filters where the user explicitly excluded some entities for a facet type. The fourth is negative search impression. When a user builds a search query, smart suggestion and type-ahead functionality may be triggered. Both services recommend standardized candidate query terms to facilitate query building. The user may look through the suggested entity list and select one. Those impressed, but unselected entities may be considered as negative candidates. The fifth may be recruiter search exclusion, which is a similar search exclusion in the recruiter tool.

The features may be organized into a record, with each record representing a unique label data point, showing a user's like or dislike of a topic (subject) in a time window, called a label time window. A label time window is a window with a start date and an end date. The length of the label time window determines the prediction horizon (prediction window), specifically how far in the future the predicted event will occur. The theory is that labels obtained from data within a particular month are more likely to be reflective of a user's interest that month than for different months. This also mean that the same event in the training data can be translated into different label points associated with different time windows. For example, a sample data point in April, 2020 may be assigned one label for interaction data occurring within the month of April, 2020 but another label for interaction data occurring within the month of July 2020.

The quality of the training labels derived from the user's explicit or implicit feedback greatly affects the performance of the machine learned models. Besides collecting labels, label preparation provides a unique technical challenge, especially when there is ambiguity of user interest in terms of title, function, and occupation of talent professionals. There are two types of ambiguities: direct conflicts and indirect conflicts. Direct conflicts are ones where a user expresses a positive interest in a subject at one time but expresses negative interest in the same subject at another time. Indirect conflicts are ones where a user expresses positive interest in one subject at one time and a negative interest in a related or parent subject at another time, such as expressing an interest in the “Software Engineer” title at one time and then a disinterest in the “Engineering” function at another time.

In an example embodiment, a taxonomy of subjects may be used to resolve the ambiguities by reducing the noise introduced from the conflicted labels. Subjects are terms or phrases with particular meaning in the system. The taxonomy may indicate relationships between the subjects, such as a relationship between Software Engineering and Software Development (and likewise a lack of relationship between Software Engineering and Cooking). The subjects may be comprised of functions, occupations, and titles. Specifically, two rules may be used to resolve the ambiguities.
Rule 1: if the same subject and same observation time are associated with two different labels, the negative label is removed.
Rule 2: In case there are conflicted labels associated with the same observation time, but two related subjects (denoted as s₁ and s₂), assume s₁ is represented by a higher order entity from the taxonomy hierarchy (e.g., a function), and s₂ is represented by a lower order entity from the taxonomy hierarchy (e.g. a title), and there is a path between them, then s₁ dominates s₂, or s₁ is a [symbol] s₂. In this case, the negative label will be removed.

Once the user interest machine learned model 308 has been trained, it may be used to generate user interest scores for each potential insight. In an example embodiment, a recommendation model 310 may then combine the user interest score and the anomaly strength score for each anomaly to arrive at a ranking score for the anomaly. In an example embodiment, the recommendation model 310 may generate this based on a weighted sum function, with the user interest score having a first weight and the anomaly strength score having a second weight. In some example embodiments, the recommendation model 310 itself may be learned via training by a machine learning algorithm using some of the techniques described earlier, where the weights are learned through this process. The result is a ranking score that is then passed to a ranker 312 that ranks the anomalies.

The ranking of the anomalies may be passed to an insight GUI generator 314. The insight GUI generator 314 may then generate a GUI to display one or more of the ranked anomalies graphically, based on the ranking. The GUI may take many forms, including a graph in which the top ranked anomalies are highlighted. It should be noted that “top” in this context could be based on a particular set number of top anomalies to highlight (e.g., top 10 ranked anomalies) or may be based on the ranking score itself, where only anomalies with ranking scores transgressing a predetermined threshold are highlighted.

Additionally, in an example embodiment, the threshold may be dynamically adjusted as opposed to predetermined and may be personalized based on a number of factors. For example, in one example embodiment, each company's data could potentially have its own threshold, set independently of other companies' thresholds. In another example embodiment, the threshold may be determined based on the viewing user, and possibly could be output from a machine learned algorithm trained to generate a value representing a “best” threshold for a user with the same attributes as the viewing user. For example, certain users may be more likely to be interested in small variations in the underlying data than other users, and thus these certain users (or users like these certain users) may be dynamically assigned a lower threshold than other users.

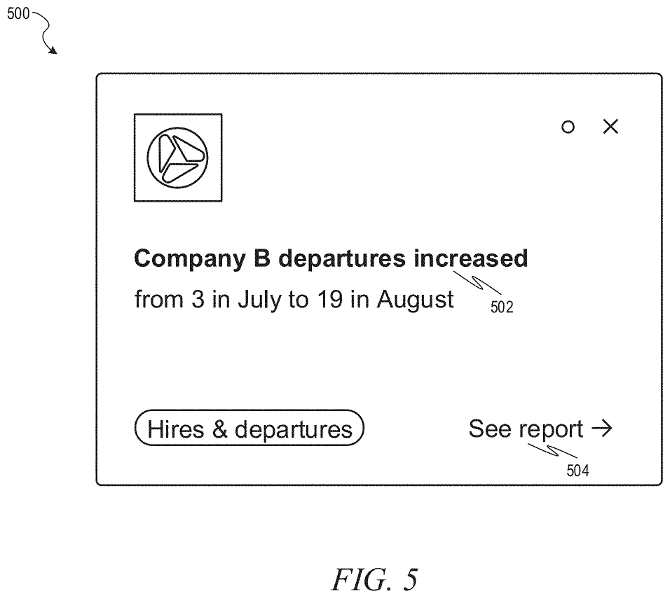

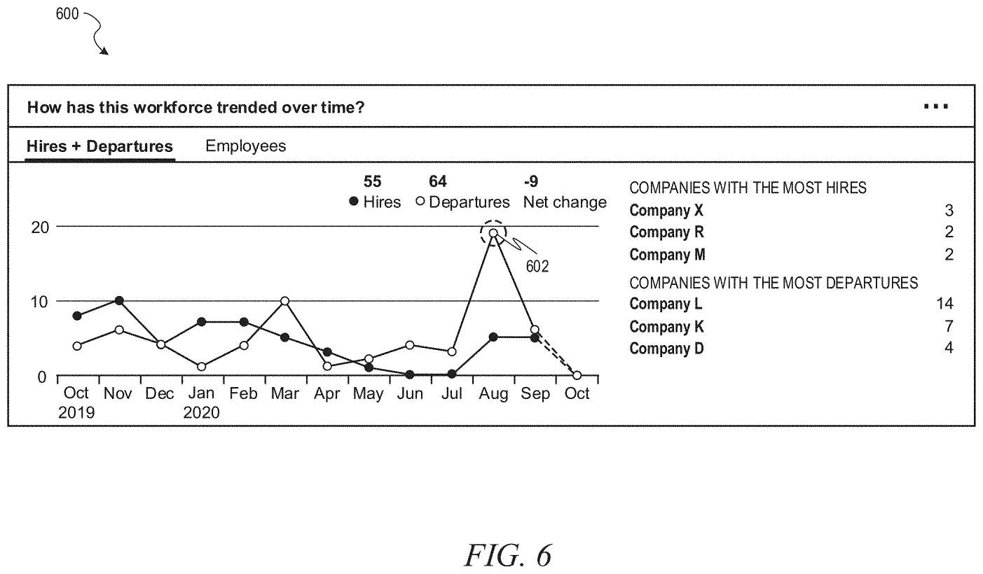

FIGS. 5 and 6 are examples of GUIs presenting insights regarding the anomalies detected using the above method. FIG. 5 is a screen capture illustrating an insights screen 500 of a GUI, in accordance with an example embodiment. Here, a text indication 502 of the anomaly is presented, along with a link 504 for the viewer to select to see the entire report. Selection of link 504 causes the GUI in FIG. 6 to be launched. FIG. 6 is a screen capture illustrating an anomaly report screen 600 of GUI, in accordance with an example embodiment. Here, anomaly 602 is highlighted graphically to illustrate where the anomaly is in the time series and how different it is from other data points.

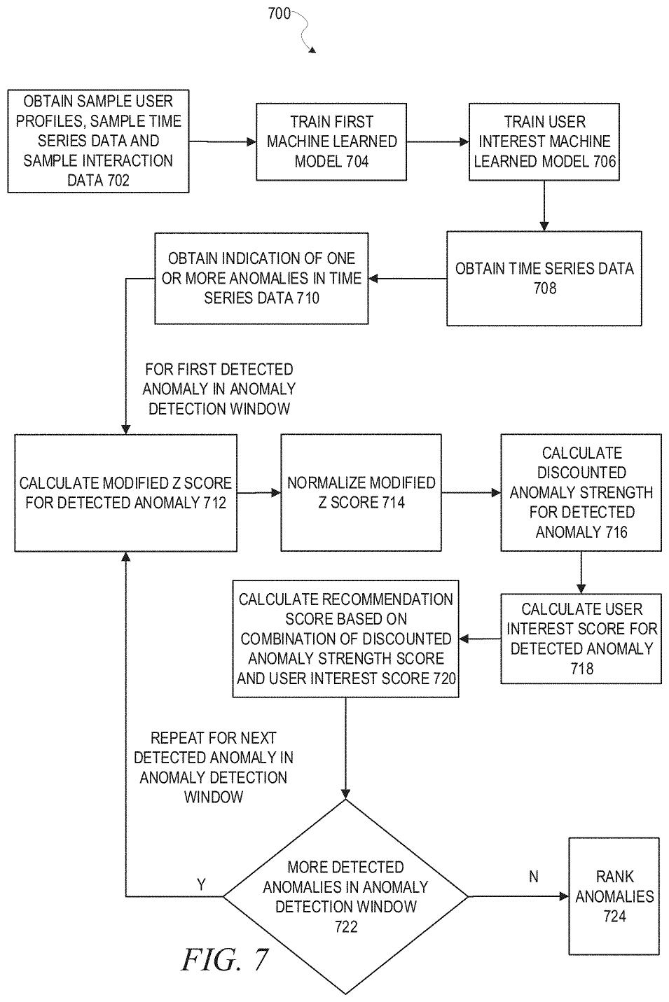

FIG. 7 is a flow diagram illustrating a method 700 of training and using an anomaly strength machine learned model 306, in accordance with an example embodiment. First the anomaly strength machine learned model is trained to learn weights, specifically k₁ and k₂. This is performed by gathering sample data and using the sample data as training data to train the anomaly strength machine learned model. Thus, at operation 702, sample user profiles, sample time series data, and sample interaction data are obtained. The sample interaction data indicates interactions between users corresponding to the sample user profiles and ranked anomalies, from the sample time series data, presented in a graphical user interface. At operation 704, a first machine learned model is trained using the sample user profiles, sample time series data, and sample interaction data, to output a discounted anomaly strength score for an anomaly in a time series passed as input to the first machine learned model.

At operation 706, a user interest machine learned model is trained to generate a user interest score for an insight (e.g., an anomaly) based on a prediction of a user's interest in the insight. Specifically, this score is indicative of how likely it is that a user would be interested in the insight. This training may or may not use the same sample user profiles, sample time series data, and sample interaction data as obtained in operation 702. Additionally, while depicted in this figure as being performed after operation 704, this training may be performed prior to, or simultaneously with the training in operation 704.

At operation 708, time series data is obtained. The time series data includes a value for a first metric at each of a plurality of time points separated by time intervals. At operation 710, an indication of one or more anomalies in the time series data is received. One method for performing operation 708 is disclosed in the co-pending application entitled “TIME SERIES ANOMALY DETECTION,” filed on the same day as the present application and incorporated by reference as described above.

A loop is then begun for each of the one or more detected anomalies. At operation 712, a modified Z score is calculated for the anomaly using the trained first machine learned model. The modified Z score is a value of the first metric for the anomaly minus a median of values for the first metric in the time series data, divided by a median absolute deviation between the value of the first metric for the anomaly and values of the first metric in the time series data, when the median absolute deviation is non-zero.

At operation 714, the modified Z score is normalized. At operation 716, a discounted anomaly strength is calculated for the anomaly, based on the normalized modified Z score for the anomaly and based on parameters to control slope and shift of a sigmoid function applied to the modified Z score.

Optionally, at operation 718, a user interest score is calculated for the anomaly, using the user interest machine learned model trained in operation 706. At operation 720, a recommendation score is calculated for the anomaly, based on a combination of the discounted anomaly strength score for the anomaly and the user interest score for the anomaly (if used).

At operation 722, it is determined if there are any more detected anomalies in the anomaly detection window. If so, then the method loops back to 708 for the next detected anomaly. If not, then at operation 724 at least one of the one or more detected anomalies is ranked against at least one anomaly from different time series data, based on a comparison of the recommendation score calculated for the at least one of the one or more anomalies and a recommendation score calculated for the at least one anomaly from different time series data.

It should be noted that the training and use of the user interest score machine learned model is optional, and a similar process to that in FIG. 7 can be performed using only the anomaly strength scores calculated by the anomaly strength machine learned model.

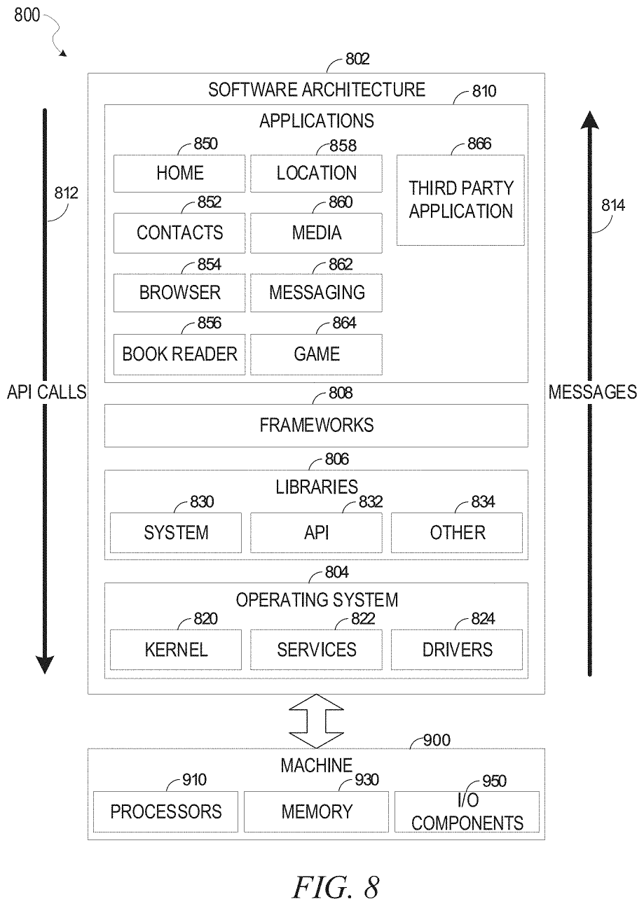

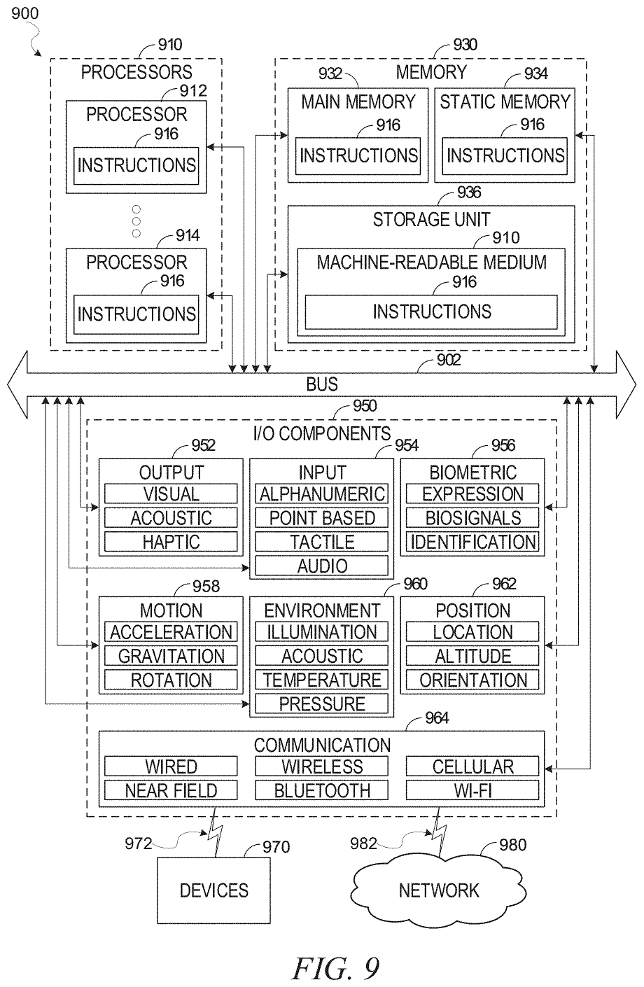

FIG. 8 is a block diagram 800 illustrating a software architecture 802, which can be installed on any one or more of the devices described above. FIG. 8 is merely a non-limiting example of a software architecture, and it will be appreciated that many other architectures can be implemented to facilitate the functionality described herein. In various embodiments, the software architecture 802 is implemented by hardware such as a machine 900 of FIG. 9 that includes processors 910, memory 930, and input/output (I/O) components 950. In this example architecture, the software architecture 802 can be conceptualized as a stack of layers where each layer may provide a particular functionality. For example, the software architecture 802 includes layers such as an operating system 804, libraries 806, frameworks 808, and applications 810. Operationally, the applications 810 invoke API calls 812 through the software stack and receive messages 814 in response to the API calls 812, consistent with some embodiments.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some embodiments. For example, the kernel 820 provides memory management, processor management (e.g., scheduling), component management, networking, and security settings, among other functionality. The services 822 can provide other common services for the other software layers. The drivers 824 are responsible for controlling or interfacing with the underlying hardware, according to some embodiments. For instance, the drivers 824 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 806 provide a low-level common infrastructure utilized by the applications 810. The libraries 806 can include system libraries 830 (e.g., C standard library) that can provide functions such as memory allocation functions, string manipulation functions, mathematic functions, and the like. In addition, the libraries 806 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810, according to some embodiments. For example, the frameworks 808 provide various GUI functions, high-level resource management, high-level location services, and so forth. The frameworks 808 can provide a broad spectrum of other APIs that can be utilized by the applications 810, some of which may be specific to a particular operating system 804 or platform.

In an example embodiment, the applications 810 include a home application 850, a contacts application 852, a browser application 854, a book reader application 856, a location application 858, a media application 860, a messaging application 862, a game application 864, and a broad assortment of other applications, such as a third-party application 866. According to some embodiments, the applications 810 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 866 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 866 can invoke the API calls 812 provided by the operating system 804 to facilitate functionality described herein.

FIG. 9 illustrates a diagrammatic representation of a machine 900 in the form of a computer system within which a set of instructions may be executed for causing the machine 900 to perform any one or more of the methodologies discussed herein, according to an example embodiment. Specifically, FIG. 9 shows a diagrammatic representation of the machine 900 in the example form of a computer system, within which instructions 916 (e.g., software, a program, an application 810, an applet, an app, or other executable code) for causing the machine 900 to perform any one or more of the methodologies discussed herein may be executed. For example, the instructions 916 may cause the machine 900 to execute the method 700 of FIG. 7. Additionally, or alternatively, the instructions 916 may implement FIGS. 1-9, and so forth. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a PC, a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 912 and a processor 914 that may execute the instructions 916. The term “processor” is intended to include multi-core processors 910 that may comprise two or more independent processors 912 (sometimes referred to as “cores”) that may execute instructions 916 contemporaneously. Although FIG. 9 shows multiple processors 910, the machine 900 may include a single processor 912 with a single core, a single processor 912 with multiple cores (e.g., a multi-core processor), multiple processors 910 with a single core, multiple processors 910 with multiple cores, or any combination thereof.

The memory 930 may include a main memory 932, a static memory 934, and a storage unit 936, all accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine 900 will depend on the type of machine 900. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion, and the grouping is in no way limiting. In various example embodiments, the I/O components 950 may include output components 952 and input components 954. The output components 952 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 962 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 930, 932, 934, and/or memory of the processor(s) 910) and/or the storage unit 936 may store one or more sets of instructions 916 and data structures (e.g., software) embodying or utilized by any one or more of the methodologies or functions described herein. These instructions (e.g., the instructions 916), when executed by the processor(s) 910, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 916 and/or data. The terms shall accordingly be taken to include, but not be limited to, solid-state memories, and optical and magnetic media, including memory internal or external to the processors 910. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 980 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 916 may be transmitted or received over the network 980 using a transmission medium via a network interface device (e.g., a network interface component included in the communication components 964) and utilizing any one of a number of well-known transfer protocols (e.g., HTTP). Similarly, the instructions 916 may be transmitted or received using a transmission medium via the coupling 972 (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system for training and using a machine learned model, comprising:
a computer-readable medium having instructions stored thereon, which, when executed by a processor, cause the system to perform operations comprising:
obtaining sample user profiles, sample time series data, and sample interaction data, the sample interaction data indicating interactions between users corresponding to the sample user profiles and ranked anomalies that have been presented in a graphical user interface, the ranked anomalies being from the sample time series data;
training a first machine learned model using the sample user profiles, sample time series data, and sample interaction data, to cause the first machine learned model to be trained to take a user profile and an anomaly in time series data and calculate a discounted anomaly strength for the anomaly in the time series data;
obtaining time series data, the time series data including a value for a first metric at each of a plurality of time points separated by time intervals;
obtaining an indication of one or more anomalies in the time series data;
for at least one of the one or more anomalies:
calculating a discounted anomaly strength for the anomaly, using the trained first machine learned model, based on a modified Z score for the anomaly and based on parameters to control slope and shift of a first sigmoid function applied to the modified Z score, the modified Z score being the value of the first metric for the anomaly minus a median of values for the first metric in the time series data, divided by a median absolute deviation between the value of the first metric for the anomaly and values of the first metric in the time series data, when the median absolute deviation is non-zero; and
ranking the at least one of the one or more anomalies against at least one anomaly from different time series data, based on a comparison of the discounted anomaly strength calculated for the at least one of the one or more anomalies and a discounted anomaly strength calculated for the at least one anomaly from different time series data.

2. The system of claim 1, wherein the modified Z score is:
$$\{ \begin{matrix}\frac{{x}_{i} - \tilde{X}}{{k}_{1} \cdot MeanAd} & ( MAD = 0 ) \\ \frac{{x}_{i} - \tilde{X}}{{k}_{2} \cdot MAD} & ( M A D \neq 0 )\end{matrix} \\ where \\ MAD = median ( \vert {x}_{i} - \tilde{X} \vert ) and MeanAD = \frac{1}{n} {\sum }_{i}^{n} \vert {x}_{i} - m ( X ) \vert$$
and for a set X={xi|xi∈ [symbol] , i=1, 2, . . . , n}, let \tilde{X}=median(X), where [symbol] is the time series data and k₁ and k₂ are weights.

3. The system of claim 2, wherein k₁ and k₂ are learned via the training.

4. The system of claim 1, wherein the operations further comprise normalizing the modified Z score by applying a second sigmoid function.

5. The system of claim 1, wherein the operations further comprise:
training a second machine learned model to cause the second machine learned model to take an insight about time series data and calculate a user interest score for the anomaly, the user interest score indicative of a likelihood that a user will select the insight in a graphical user interface.

6. The system of claim 5, wherein the operations further comprise:
for at least one of the one or more anomalies:
calculating a user interest score for the anomaly using the second machine learned model;
calculating a recommendation score for the anomaly based on a combination of the user interest score for the anomaly and the discounted anomaly strength score for the anomaly;
wherein the ranking is based on a comparison of the recommendation score for the anomaly and a recommendation score calculated for the at least one anomaly from different time series data.

7. The system of claim 1, wherein the parameters are learned via the training.

8. The system of claim 1, wherein the operations further comprise retraining the first machine learned model based on user feedback.

9. The system of claim 1, wherein the operations further comprise generating a graphical user interface in which values labeled as anomalies are graphically highlighted.

10. The system of claim 1, wherein the machine learning algorithm is a neural network.

11. The system of claim 1, wherein the time series data is decomposed into a trend component, seasonal component, and remainder component, and the anomalies in the time series data are identified based on the remainder component.

12. A computerized method comprising:
obtaining sample user profiles, sample time series data, and sample interaction data, the sample interaction data indicating interactions between users corresponding to the sample user profiles and ranked anomalies that have been presented in a graphical user interface, the ranked anomalies being from the sample time series data;
training a first machine learned model using the sample user profiles, sample time series data, and sample interaction data, to cause the first machine learned model to be trained to take a user profile and an anomaly in time series data and calculate a discounted anomaly strength for the anomaly in the time series data;
obtaining time series data, the time series data including a value for a first metric at each of a plurality of time points separated by time intervals;
obtaining an indication of one or more anomalies in the time series data;
for at least one of the one or more anomalies:
calculating a discounted anomaly strength for the anomaly, using the trained first machine learned model, based on a modified Z score for the anomaly and based on parameters to control slope and shift of a first sigmoid function applied to the modified Z score, the modified Z score being the value of the first metric for the anomaly minus a median of values for the first metric in the time series data, divided by a median absolute deviation between the value of the first metric for the anomaly and values of the first metric in the time series data, when the median absolute deviation is non-zero; and
ranking the at least one of the one or more anomalies against at least one anomaly from different time series data, based on a comparison of the discounted anomaly strength calculated for the at least one of the one or more anomalies and a discounted anomaly strength calculated for the at least one anomaly from different time series data.

13. The method of claim 12, wherein the modified Z score is:
$$\{ \begin{matrix}\frac{{x}_{i} - \tilde{X}}{{k}_{1} \cdot MeanAd} & ( MAD = 0 ) \\ \frac{{x}_{i} - \tilde{X}}{{k}_{2} \cdot MAD} & ( M A D \neq 0 )\end{matrix} \\ where \\ MAD = median ( \vert {x}_{i} - \tilde{X} \vert ) and MeanAD = \frac{1}{n} {\sum }_{i}^{n} \vert {x}_{i} - m ( X ) \vert$$
and for a set X={xi|xi∈ [symbol] , i=1, 2, . . . , n}, let \tilde{X}=median(X), where [symbol] is the time series data and k₁ and k₂ are weights.

14. The method of claim 13, wherein k₁ and k₂ are learned via the training.

15. The method of claim 12, wherein the operations further comprise normalizing the modified Z score by applying a second sigmoid function.

16. The method of claim 12, further comprising:
training a second machine learned model to cause the second machine learned model to take an insight about time series data and calculate a user interest score for the anomaly, the user interest score indicative of a likelihood that a user will select the insight in a graphical user interface.

17. The method of claim 16, further comprising:
for at least one of the one or more anomalies:
calculating a user interest score for the anomaly using the second machine learned model;
calculating a recommendation score for the anomaly based on a combination of the user interest score for the anomaly and the discounted anomaly strength score for the anomaly;
wherein the ranking is based on a comparison of the recommendation score for the anomaly and a recommendation score calculated for the at least one anomaly from different time series data.

17. The method of claim 12, wherein the discounted anomaly strength score is calculated as follows:
$${S}_{[ T - k - 1 , T ]} = \{ {S}_{t} \vert {Z}_{t}^{′} * \frac{1}{1 + {φ}^{- 1 \vert {x}_{t}^{′} - {\hat{x}}_{t}^{′} \vert * β}} \} ( t ∈ [ T - k - 1 , T ] )$$
where S is the discounted anomaly strength score, t is a time in the set of all times T of the time series, k is a length of an anomaly detection window, x^{t} is an actual value at time t in the time series and \hat{x}′ is a predicted value using the first machine learned model at time t in the time series, where φ and β are the parameters to control the slope and shift of the sigmoid function.

18. The method of claim 12, wherein the parameters are learned via the training.

19. The method of claim 12, wherein the operations further comprise retraining the machine learned model based on user feedback.

20. An apparatus comprising:
means for obtaining sample user profiles, sample time series data, and sample interaction data, the sample interaction data indicating interactions between users corresponding to the sample user profiles and ranked anomalies that have been presented in a graphical user interface, the ranked anomalies being from the sample time series data;
means for training a first machine learned model using the sample user profiles, sample time series data, and sample interaction data, to cause the first machine learned model to be trained to take a user profile and an anomaly in time series data and calculate a discounted anomaly strength for the anomaly in the time series data;
means for obtaining time series data, the time series data including a value for a first metric at each of a plurality of time points separated by time intervals;
means for obtaining an indication of one or more anomalies in the time series data;
means for, for at least one of the one or more anomalies:
calculating a discounted anomaly strength for the anomaly, using the trained first machine learned model, based on a modified Z score for the anomaly and based on parameters to control slope and shift of a first sigmoid function applied to the modified Z score, the modified Z score being the value of the first metric for the anomaly minus a median of values for the first metric in the time series data, divided by a median absolute deviation between the value of the first metric for the anomaly and values of the first metric in the time series data, when the median absolute deviation is non-zero; and
means for ranking the at least one of the one or more anomalies against at least one anomaly from different time series data, based on a comparison of the discounted anomaly strength calculated for the at least one of the one or more anomalies and a discounted anomaly strength calculated for the at least one anomaly from different time series data.
